(19) United States
(12) Patent Application Publication
(10) Pub. No.: US 2008/0101069 A1
(43) Pub. Date: May 1, 2008

(54) BACKLIGHT MODULE HAVING LIGHT-MIXING AREAS

(75) Inventor: SHAO-HAN CHANG, Tu-Cheng (TW)

Correspondence Address: PCE INDUSTRY, INC.;ATT. CHENG-JU CHIANG J, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,623

(22) Filed: Dec. 28, 2006

(30) Foreign Application Priority Data
Oct. 27, 2006 (CN) 200610201036.1

(51) Int. Cl. F21V 7/00

(52) U.S. Cl. 362/247; 362/240; 362/231

(57) ABSTRACT

An exemplary backlight module (30) includes a plurality of color light emitting diodes (31), a frame (33), and a reflective divider (35). The frame includes a base (331) and a plurality of sidewalls (335) extending from the base. The sidewalls and the base cooperatively form a receiving space (335). The color light emitting diodes are disposed on the base. The reflective divider is positioned in the receiving space such that the receiving space is divided into a plurality of light-mixing areas. The backlight module can provide good, uniform optical performance due to the light-mixing areas.

### BACKGROUND OF THE INVENTION

1. Field of the Invention

The present invention relates to backlight modules, and more particularly to a direct type backlight module typically used in a liquid crystal display (LCD).

2. Discussion of the Related Art

In a liquid crystal display device, liquid crystal is a substance that does not itself radiate light. Instead, the liquid crystal relies on light received from a light source in order to display images and data. In the case of a typical liquid crystal display device, a backlight module powered by electricity supplies the needed light.

FIG. 5 illustrates a typical direct type backlight module 10 using a plurality of colored light emitting diodes (colored LEDs). The backlight module 10 includes the plurality of colored LEDs 11, and a frame 13. The frame 13 includes a base 131, and a plurality of sidewalls 133 extending from a periphery of the base 131. The colored LEDs 11 are regularly arranged on the base 131 of the frame 13. The colored LEDs 11 are a combination of a plurality of red, green, and blue colored LEDs 11. Generally, a combination of light rays in these three primary colors, i.e. a mixture of red, green, and blue light rays, produces white light rays. By combining these red, green, and blue colored LEDs 11 in a tightly coupled pattern, an imperfect form of white light is produced. Nevertheless, the white light produced is sufficient to satisfy the requirements of the liquid crystal display.

In the backlight module 10, uniform light mixing of the light generated by the colored LEDs 11 occurs mainly by way of the light rays being reflected off the sidewalls 133 numerous times. However, if the backlight module 10 is large, a great deal of the light rays emitted from the colored LEDs 11 located away from the sidewalls 133 is not reflected by the sidewalls 133. Instead, numerous such light rays directly exit the backlight module 10 toward a liquid crystal panel (not shown) disposed above the backlight module 10. Thus, the mixing of the light generated by the colored LEDs 11 in the backlight module 10 is not uniform. That is, it is difficult to achieve complete or even substantial uniformity of white light rays emitted from the backlight module 10.

What is needed, therefore, is a new backlight module which can overcome the above-described shortcomings.

### SUMMARY

A backlight module according to a preferred embodiment includes a frame, a plurality of color light emitting diodes, and a reflective divider. The frame includes a base and a plurality of sidewalls extending from the base. The sidewalls and the base cooperatively form a receiving space. The color light emitting diodes are disposed on the base. The reflective divider is positioned in the receiving space such that the receiving space is divided into a plurality of light-mixing areas.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present backlight module. Moreover, in the drawings, like reference numerals designate corresponding parts throughout the several views, and all the views are schematic.

FIG. 1 is an exploded, isometric view of a backlight module according to a first preferred embodiment of the present invention.

FIG. 2 is a assembled view of the backlight module of FIG. 1.

FIG. 3 is a assembled, isometric view of a backlight module according to a second preferred embodiment of the present invention.

FIG. 4 is a assembled, isometric view of a backlight module according to a third preferred embodiment of the present invention.

FIG. 5 is a side cross-sectional view of a conventional direct type backlight module.

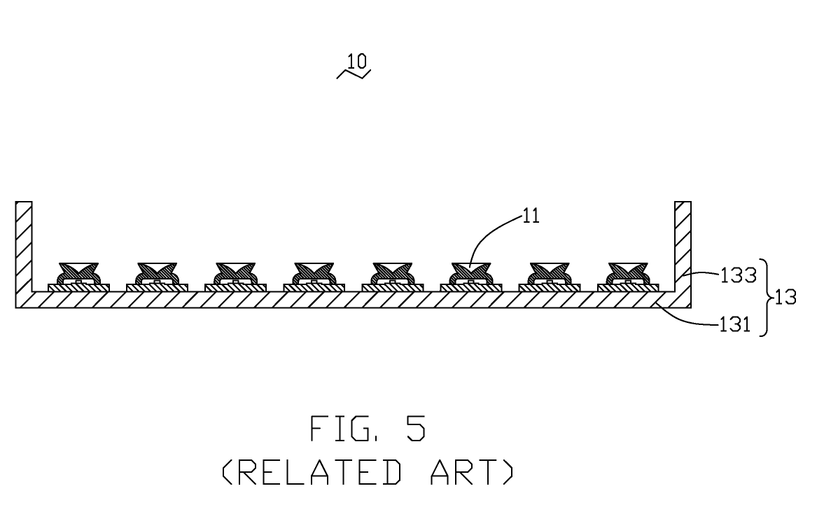

### DETAILED DESCRIPTION OF THE PREFERRED EMBODIMENTS

Reference will now be made to the drawings to describe preferred embodiments of the present backlight module, in detail.

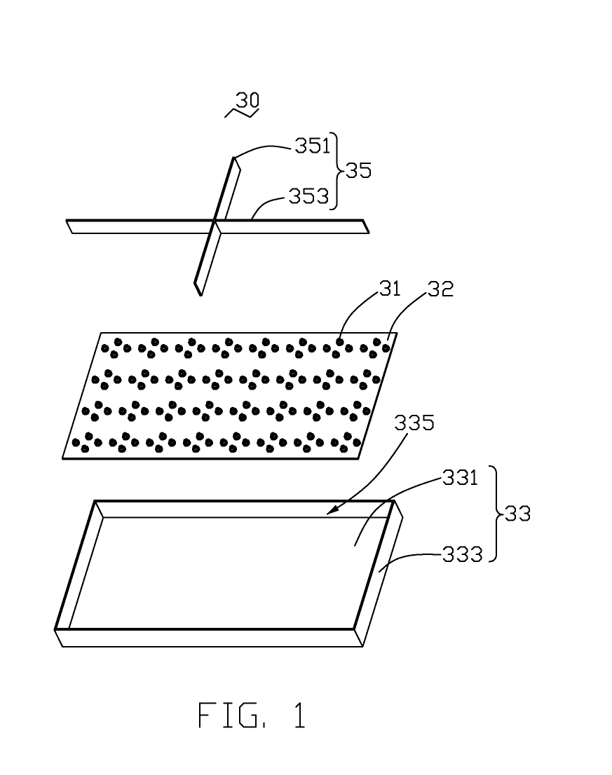

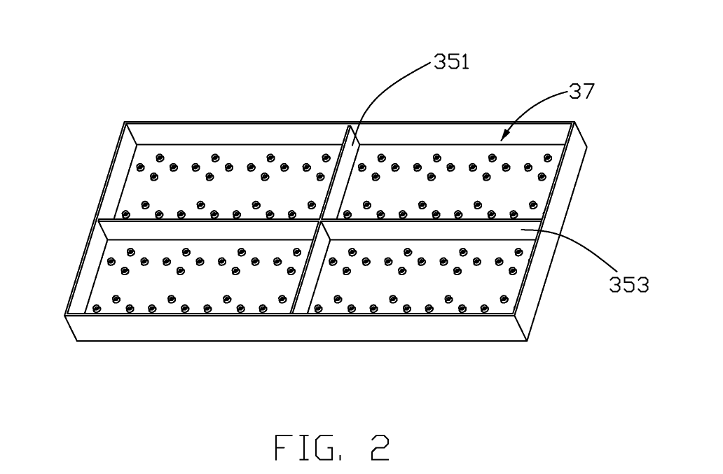

Referring to FIGS. 1 and 2, a backlight module 30 in accordance with a first preferred embodiment is shown. The backlight module 30 includes a plurality of colored LEDs 31, an aluminum based circuit board 32, a frame 33, and a reflective divider 35. The frame 33 includes a rectangular base 331, and a plurality of sidewalls 333 extending from a periphery of the base 331. The base 331 and the sidewalls 333 cooperatively form a receiving space 335. The circuit board 32 is disposed on the base 331 of the receiving space 335. The colored LEDs 31 are a combination of a plurality of red, green, and blue colored LEDs 31. The colored LEDs 31 are electrically connected on the circuit board 32 in a predetermined manner. The reflective divider 35 is positioned on the circuit board 32 in the receiving space 335, such that the receiving space 335 is divided into a plurality of light-mixing areas 37.

In this embodiment, the reflective divider 35 is cross-shaped. That is, the reflective divider 35 includes a first reflective plate 351 and a second reflective plate 353 intersecting at right angles. The first reflective plate 351 is an elongated plate. The second reflective plate 353 is similar to the first reflective plate 351, except that the second reflective plate 353 is longer than the first reflective plate 351. The first reflective plate 351 and the second reflective plate 353 are erected on the circuit board 32. Ends of the first reflective plate 351 and ends of the second reflective plate 353 abut corresponding inner surfaces of the sidewalls 333. Thus, the reflective divider is fittingly held in the receiving space 335. A height of the reflective divider 35 is configured to be less than that of the sidewalls 333.

Referring to FIG. 2, in this embodiment, the receiving space 335 of the frame 33 is divided into four light-mixing areas 37. In each light-mixing area 37, light rays from the colored LEDs 31 are substantially reflected at surfaces of the first and/or second reflective plate 351, 353, and/or inner surfaces of the sidewalls 333 many times. Thus, red, green, and blue light rays are thoroughly mixed, and uniform white light rays can be attained. The first reflective plate 351 and the second reflective plate 353 of the reflective divider 35 are configured to be attached to each other tightly. Alternatively, the first reflective plate 351 and the second reflective plate 353 can be integrally formed as a single body. In either case, assembly of the backlight module 30 is quick and convenient.

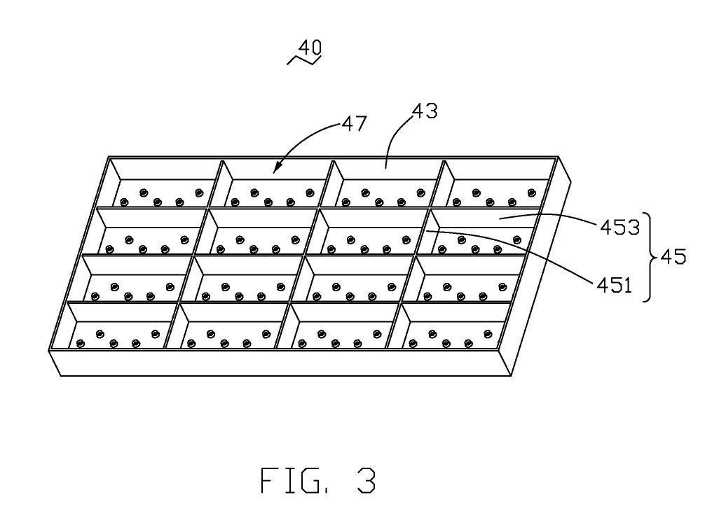

Referring to FIG. 3, a backlight module 40 in accordance with a second preferred embodiment is shown. The backlight module 40 is similar in principle to the backlight module 30 of the first embodiment, except that a reflective divider 45 of the backlight module 40 is different from the reflective divider 35 of the first embodiment. The reflective divider 45 includes three parallel first reflective plates 451 perpendicularly intersecting three parallel second reflective plates 453. The reflective divider 45 divides a receiving space (not labeled) of the frame 43 into sixteen light-mixing areas 47.

It is to be noted that the number of first reflective plates 451 and the number of second reflective plates 453 can be varied. The reflective divider 45 may employ at least one first reflective plate 451 and at least one second reflective plate 453, as long as the at least one first reflective plate 451 and the at least one second reflective plate 453 cooperatively divide the receiving space of the frame 43 into a plurality of light-mixing areas 47. It is to be also understood that the first reflective plate 451 can be slanted relative to the second reflective plate 453. That is, an angle defined by the first reflective plate 451 with respect to the second reflective plate 453 can be a right angle or an oblique angle.

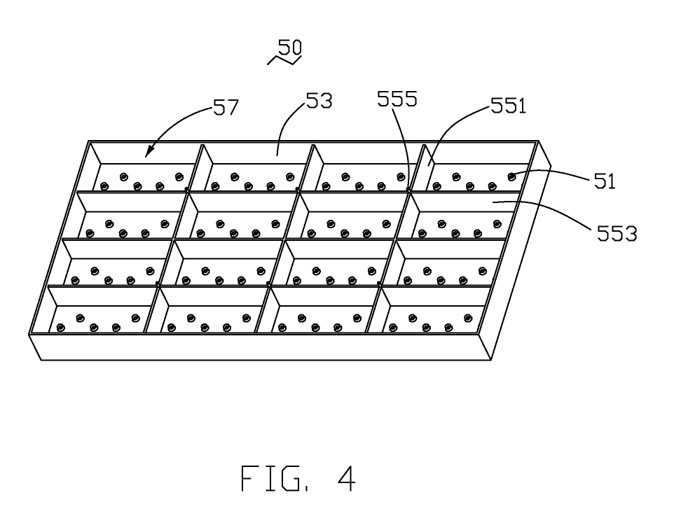

Referring to FIG. 4, a backlight module 50 in accordance with a third preferred embodiment is shown. The backlight module 50 is similar in principle to the backlight module 40 of the second embodiment. However, the backlight module 50 includes a reflective divider 55. The reflective divider 55 includes a plurality of supporting posts 555 located at selected of intersections of the first reflective plates 551 and the second reflective plates 553. Each supporting post 555 extends up from the respective intersection. Further or alternatively, the supporting posts 555 can be located on upper edges of selected of the first reflective plates 551 and the second reflective plates 553. The backlight module 50 may further include at least one optical plate (not shown) located on the top of the frame 53 above a receiving space (not labeled) thereof. The supporting posts 555 are configured to support the at least one optical plate. Colored light rays from colored LEDs 51 are substantially reflected and mixed in each of light-mixing areas 57, such that uniform white light rays can be attained. The white light rays are diffused in the at least one optical plate, so that substantially planar light is outputted from the at least one optical plate.

It is to be understood that in alternative embodiments, any reflective surface of each first reflective plate and each second reflective plate of the reflective divider may be oriented at an oblique angle with respect to the base of the frame. The oblique angle can for example be in the vicinity of 90 degrees. Alternatively, any reflective surface of each first reflective plate and each second reflective plate may be arched, such that the reflective surface is concave relative to the base.

It is to be further understood that the circuit board of the above-described embodiments can be omitted. In such cases, the reflective divider is directly disposed on the base of the frame. The backlight module may further include a reflective plate disposed around base portions of the colored LEDs, for improving a light energy utilization rate of the backlight module. In such case, the reflective plate defines a plurality of through holes corresponding to the colored LEDs, and a light-emitting portion of each colored LED is exposed above a respective through hole of the reflective plate. Further, the reflective divider can be located on the reflective plate.

The first reflective plate and the second reflective plate of the reflective divider are made of plastic or highly reflective metallic material. If the first and second reflective plates are made of plastic, a high reflectivity film can be coated on the two main surfaces of each first reflective plate and each second reflective plate. Alternatively, reflective sheets can be affixed on the main surfaces of the first and second reflective plates. It is to be further understood that the inner surfaces of the sidewalls can also be configured to be reflective. This can be achieved by coating high reflectivity films thereon or by affixing reflective sheet thereon.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A backlight module comprising:
a frame having a base and a plurality of sidewalls extending from the base, the sidewalls and the base cooperatively forming a receiving space;
a plurality of colored light emitting diodes disposed at the base; and
a reflective divider positioned in the receiving space such that the receiving space is divided into a plurality of light-mixing areas.

2. The backlight module according to claim 1, wherein the reflective divider includes at least one first reflective plate and at least one second reflective plate intersecting the at least one first reflective plate.

3. The backlight module according to claim 2, wherein ends of the at least one first reflective plate and ends of the at least one second reflective plate abut the inner surface of the sidewalls, such that the reflective divider is restricted in the receiving space.

4. The backlight module according to claim 2, wherein the at least one first reflective plate and the at least one second reflective plate are integrally manufactured.

5. The backlight module according to claim 2, wherein the base is rectangular, the at least one first reflective plate parallels to two opposite sidewalls, and the at least one second reflective plate parallels to other two opposite sidewalls.

6. The backlight module according to claim 1, wherein the reflective divider comprises a plurality of first reflective plates and a plurality of second reflective plates, the first reflective plates intersect with the second reflective plates in series, the first reflective plates parallel to each other and the second reflective plates also parallel to each other.

7. The backlight module according to claim 2, wherein any reflective surfaces of the at least one first reflective plate and the at least one reflective plate of the present reflective divider can be oriented at an oblique or right angles with the base of the frame.

8. The backlight module according to claim 2, wherein heights of the first reflective plate and the second reflective plate of the reflective divider are smaller than those of the sidewalls.

9. The backlight module according to claim 8, further comprising at least one supporting post located at selected of intersections of the first reflective plate and the second reflective plate of the reflective divider.

10. The backlight module according to claim 2, wherein the at least one first reflective plate and the at least one second reflective plate of the reflective divider are made of one of plastic and metal materials.

11. The backlight module according to claim 10, wherein each first reflective plate and each second reflective plate further comprise a high reflectivity film coated on the two main surfaces thereof.

12. The backlight module according to claim 10, wherein each first reflective plate and each second reflective plate further comprise reflective sheets affixed on the two main surfaces thereof.

13. The backlight module according to claim 1, wherein the backlight module further comprises at least one optical plate located on the tops of the frame over the receiving space.

14. The backlight module according to claim 1, wherein the backlight module may further comprises a reflective plate disposed on the light emitting diodes; the reflective plate defines a plurality of through holes corresponding to the light emitting diodes, illuminate portion of each light emitting diode passes through the corresponding through hole of the reflective plate.

15. The backlight module according to claim 1, wherein the colored light emitting diodes comprises at least one blue light emitting diode, at least one red light emitting diode, and at least one green light emitting diode in each light-mixing area.
